(19) United States
(12) Patent Application Publication
(10) Pub. No.: US 2026/0310555 A1
(43) Pub. Date: Oct. 8, 2026

(54) SYNCHRONIZING DATA RECOVERY LOGS FOR SNAPSHOT-BASED DATA RECOVERY IN A DISTRIBUTED DEDUPLICATION SYSTEM

(71) Applicant: Dell Products L.P., Round Rock, TX (US)

(72) Inventors: Uday Kiran Jonnala, Cupertino, CA (US); Fani Jenkins, Boulder, CO (US); Srisailendra Yallapragada, Cupertino, CA (US); George Mathew, Belmont, CA (US); Murthy V. Mamidi, Queen Creek, AZ (US); Abhishek Rajimwale, San Jose, CA (US)

(21) Appl. No.: 19/172,657

(22) Filed: Apr. 8, 2025

(51) Int. Cl. G06F 11/14

(52) U.S. Cl. CPC G06F 11/1458; G06F 16/21; G06F 16/275

(57) ABSTRACT

A data logging system and method that provides a single consistency point for cluster file systems to facilitate snapshot-based recovery in a deduplication backup system. Recovery logs for similarity groups in a cluster file system are each organized into a plurality of uniform log data units where the recovery logs may be filled at different rates. When a log data unit is filled, it is synced to disk storage. The recovery log is truncated at the filled log data unit, and new log data is appended to the head of the log. Each filled log data unit is timestamped when it is synced to the disk. The earliest timestamp of the filled log data units is used to match a snapshot backup of the cluster file system taken at a same corresponding time for use as a backup image for restoring the cluster file system.

### TECHNICAL FIELD

Embodiments are directed to distributed deduplication file system networks, and a snapshot-based recovery mechanism using a single, cluster-wide recovery point.

### BACKGROUND

A distributed (or cluster) file system is a type of file system in which data is spread across multiple storage devices as may be provided in a cluster of nodes. Each computer forms a node in the system and runs its own instance of an operating system. The file system is shared by being simultaneously mounted on multiple servers, and presents a global namespace to the nodes so that files appear to be in the same central location. Distributed file systems are typically very large and may contain many hundreds of thousands or even many millions of files, as well as services (applications) that use and produce data. The Santorini file system provided by Dell Technologies, Inc. represents a type of cluster network system that stores the file system metadata on a distributed key value store and the file data on object store. The metadata can be accessed by any front-end node, and any file can be opened for read/write by any front-end node.

File systems often utilize a high-speed recovery log, typically stored in a non-volatile RAM (NVRAM) device to stage recently written data in order to optimize write performance. For example, a single-node file system uses an NVRAM device to stage user data for the purpose of recovery in the event of a crash. Some file systems implement frequent flushing of data from staged storage to persistent storage (e.g., disk) to recover from cases where the NVRAM content may be lost or corrupted. If NVRAM content is lost or corrupt, the staged data content is no longer recoverable, thus resulting in data loss. To prevent this data loss, file systems regularly flush data from the recovery log (e.g., every N minutes) to ensure that any potential data loss is limited to these last N minutes.

If a recovery log is lost, data recovery is performed by rolling back the file system to a previous consistent recovery point. The recovery point contains data which has already been flushed to disk. In a single-node system, a consistent recovery point can be found by simply scanning log or configuration files for the timestamp of the recovery point. This recovery procedure, however, does not scale well in clustered file systems where data is distributed among nodes to load balance the cluster resources across all nodes in the cluster. In a typical clustered file system, data writes are routed to different nodes that host one or more deduplication domains, referred to similarity groups (simgroups). Each simgroup utilizes its own recovery log for staging data, and flushing staged data every N minutes for a possibly high number of simgroups can become resource intensive.

What is needed, therefore, is a logging mechanism that provides a single consistency point for cluster file systems to facilitate snapshot-based recovery in a deduplication backup system.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Dell, Data Domain, and Santorini are trademarks of Dell Technologies, Inc.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 is a block diagram of illustrating a distributed system implementing comprehensive logging for cluster networks, under some embodiments.

FIG. 2 illustrates a high-level overview of a network cluster using the Santorini architecture, under some embodiments.

FIG. 3 illustrates details of the services related to the data path running in Santorini cluster network, under some embodiments.

FIG. 4 shows an example clustered file system that implements a cluster-wide consistency point, under some embodiments.

FIG. 5 illustrates a structure of an example recovery log for a similarity group, under some embodiments.

FIG. 6 illustrates a system providing a consistent recovery point for many disparate recovery logs in a cluster system, under some embodiments.

FIG. 7 is a flowchart that illustrates providing a single consistency point for cluster file systems to facilitate snapshot-based recovery in a deduplication backup system, under some embodiments.

FIG. 8 is a block diagram of a computer system used to execute one or more software components for the distributed system of FIG. 1, under some embodiments.

### DETAILED DESCRIPTION

A detailed description of one or more embodiments is provided below along with accompanying figures that illustrate the principles of the described embodiments. While aspects of the invention are described in conjunction with such embodiments, it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium. Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. In this specification, these implementations, or any other form that the invention may take, may be referred to as techniques. In general, the order of the steps of disclosed processes may be altered within the scope of the described embodiments.

Embodiments are directed to a data logging system and method that provides a single consistency point for cluster file systems to facilitate snapshot-based recovery in a deduplication backup system.

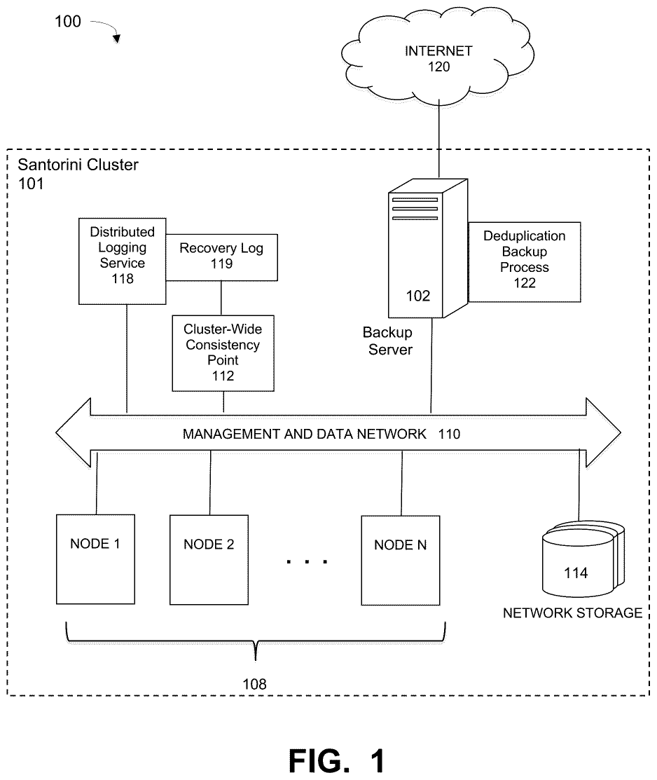

FIG. 1 is a block diagram illustrating a distributed system implementing a single consistent recovery point for snapshot-based recovery, under some embodiments. System 100 comprises a large-scale network that includes a cluster network 101 having a number of different devices, such as server or client computers 102, nodes 108, storage devices 114, and other similar devices or computing resources. Other networks may be included in system 100 including local area network (LAN) or cloud networks, and virtual machine (VM) storage or VM clusters. These devices and network resources may be connected to a central network, such as a data and management network 110 that itself may contain a number of different computing resources (e.g., computers, interface devices, and so on). FIG. 1 is intended to be an example of a representative system implementing a distributed computing system under some embodiments, and many other topographies and combinations of network elements are also possible.

A distributed system 101 (also referred to as a cluster system, cluster file system, or cluster network) typically consists of various processing components that run in different computer systems (nodes) that are connected to each other. These components communicate with each other over the network via messages and based on the message content, perform certain acts like reading data from the disk into memory, writing data stored in memory to the disk, perform some computation (CPU), sending another network message to the same or a different set of components and so on. These acts or ‘component actions,’ when executed in time order in a distributed system constitute a distributed operation.

A distributed system may comprise any practical number of compute nodes 108. For system 100, n nodes 108 denoted Node 1 to Node N are coupled to each other and a connection manager 102 through network 110. The connection manager can control automatic failover for high-availability clusters, monitor client connections and direct requests to appropriate servers, act as a proxy, prioritize connections, and other similar tasks.

In an embodiment, cluster network 101 may be implemented as a Santorini cluster that supports applications such as a data backup management application that coordinates or manages the backup of data from one or more data sources, such as other servers/clients to storage devices, such as network storage 114 and/or virtual storage devices, or other data centers. The data generated or sourced by system 100 may be stored in any number of persistent storage locations and devices, such as local client or server storage. The storage devices represent protection storage devices that serve to protect the system data through applications 104, such as a backup process that facilitates the backup of this data to the storage devices of the network, such as network storage 114, which may at least be partially implemented through storage device arrays, such as RAID (redundant array of independent disks) components. The data backup system may comprise a Data Domain system, in which case network 101 supports various related file system and data managers, such as PowerProtect Data Manager (PPDM), as well as services such as ObjectScale object storage and other services.

In an embodiment, network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays for use by a backup server, such as a server that may be running Networker or Avamar data protection software backing up to Data Domain protection storage, such as provided by Dell Technologies, Inc.

Although embodiments are described in the context of Data Domain file system (DDFS) and a Santorini cluster system, embodiments are not so limited and any architecture that requires a distributed logging service within given, configurable resources may be used.

Cluster network 101 includes a network 110 and also provides connectivity to other systems and components, such Internet 120 connectivity. The networks may be implemented using protocols such as Transmission Control Protocol (TCP) and/or Internet Protocol (IP), well known in the relevant arts. In a cloud computing environment, the applications, servers and data are maintained and provided through a centralized cloud computing platform.

In an embodiment, cluster network 101 implements containerization technology through a Kubernetes implementation. A container is a virtualized computing environment to run an application program as a service or microservice, and are lightweight, portable data constructs that are decoupled from the underlying infrastructure. Applications are run by containers as microservices with the container orchestration service facilitating scaling and failover. For example, the container orchestration service can restart containers that fail, replace containers, kill containers that fail to respond to health checks, and will withhold advertising them to clients until they are ready to serve.

In an embodiment, system 100 uses Kubernetes as an orchestration framework for clustering the nodes 1 to N in FIG. 1. Application containerization is an operating system level virtualization method for deploying and running distributed applications without launching an entire VM for each application. Instead, multiple isolated systems are run on a single control host and access a single kernel. The application containers hold the components such as files, environment variables and libraries necessary to run the desired software to place less strain on the overall resources available. Containerization technology involves encapsulating an application in a container with its own operating environment, and the well-established Docker program deploys containers as portable, self-sufficient structures that can run on everything from physical computers to VMs, bare-metal servers, cloud clusters, and so on. The Kubernetes system manages containerized applications in a clustered environment to help manage related, distributed components across varied infrastructures. Certain applications, such as multi-sharded databases running in a Kubernetes cluster, spread data over many volumes that are accessed by multiple cluster nodes in parallel.

In Kubernetes, a pod is the smallest deployable data unit that can be created and managed. A pod is a group of one or more containers, with shared storage and resource requirements. Pods are generally ephemeral entities, and when created, are scheduled to run on a node in the cluster. The pod remains on that node until the pod finishes execution.

In an embodiment, the support bundle process 112 is used in a clustered network that implements Kubernetes clusters. One such example network is the Santorini system or architecture, though other similar systems are also possible.

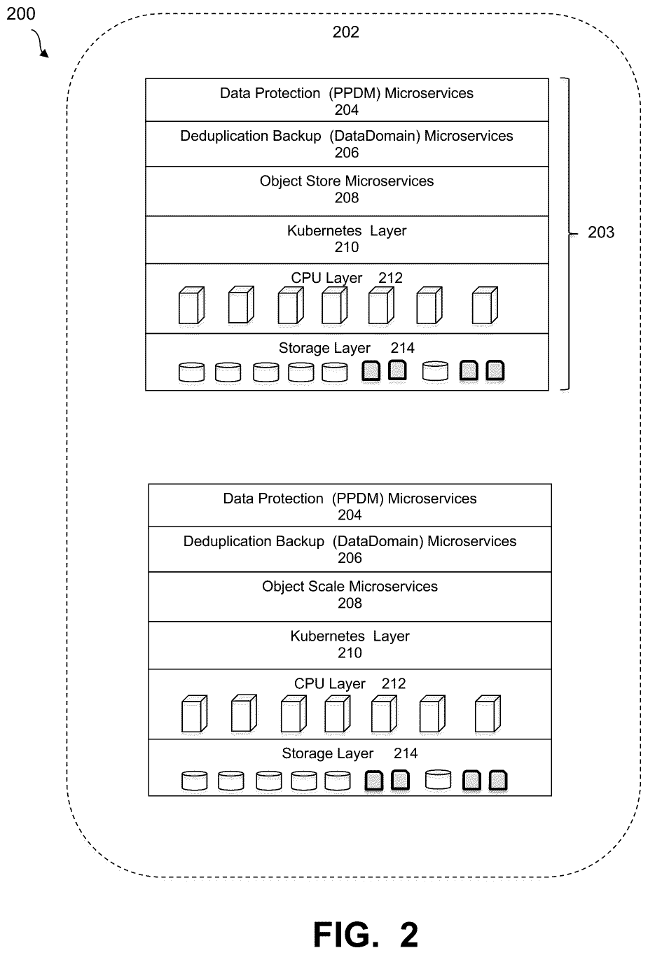

FIG. 2 illustrates a high-level overview of a network cluster using the Santorini architecture, under some embodiments. In system 200 of FIG. 2, a two-node cluster 202 is shown. Each node 203 consists of several distinct components or processing layers. For the example shown, a node includes a PowerProtect Data Manager (PPDM), or similar microservices layer 203, a Data Domain (deduplication backup) appliance microservices layer 206, an object storage (e.g., Dell ObjectScale) microservices layer 208, a Kubernetes layer 210, a processor layer 212, and a storage layer 214 including different types of storage media, such as HDD, Flash memory, SSD memory, and so on. Each of these component products consists of multiple microservices, and as more nodes are added, Santorini scales CPU, storage, RAM, and networking accordingly. Other layers can also be included, and a cluster 202 may comprise any practical number of nodes 203. The PPDM represents a cloud-native data protection manager system, and ObjectScale represents a scalable object storage manager.

As shown in FIG. 2, embodiments of the cluster network 200 through DD microservices 206 utilize Data Domain backup appliances to provide streaming deduplication, and which use the Data Domain File System (DDFS) as an inline data deduplication file system. As data gets written to the file system, DDFS creates variable sized segments and writes the unique segments to a compression region. A number of compression regions are grouped together and written as a container to disk. DDFS calculates fingerprint signatures for each segment using SHA1 algorithm. DDFS has an on-disk fingerprint index table, which maps the fingerprint to the container-ID, that has the corresponding segment data. The container has a metadata section followed by several data sections. The data sections store the compression regions; and the container metadata section stores the meta information of the container, i.e., it stores the total number of compression regions, the total number of segments, the fingerprint of each segment, and so on.

In a deduplicated file system that forms segments from data, these segments are uniquely identified by their key/label called a ‘fingerprint.’ Given a file offset and length, the corresponding data segment fingerprints need to be looked up. To provide faster offset to fingerprint lookup the mapping is stored in a Merkle tree format where the leaf nodes represent data segments and their fingerprints are stored in the parent nodes which are metadata segments. In a Merkle tree, every non-leaf node is labeled with the hash of the labels of its children nodes to allow efficient and secure verification of the contents of large data structures.

With respect to the directory tree structure of the data processed in system 100, various different data structures can be supported by the file system (e.g., DDFS or Santorini file system). A B+ Tree is self-balancing tree structure and is a variant of a standard B Tree, and Each file inode is stored in the B+ Tree as a data blob using the parent directory inode number and the child file inode number as the key. A B+ Tree key structure composed of the parent directory inode as the primary key and child file inode as the secondary key to construct the full key. An Mtree is a tree data structure similar to a B+ Tree (or R-tree), which is constructed using a metric and relies on triangle inequality for efficient range and k-nearest neighbor queries. As with other tree-based data structures, the Mtree is composed of nodes and leaves. In each node there is a data object that identifies it uniquely and a pointer to a sub-tree where its children reside. Every leaf has several data objects

A file in DDFS is represented by a Merkle tree with user data as variable sized segments at the bottom level of the tree, referred to as L0 segments. The SHA1 fingerprints of those segments are grouped together at the next higher level of the tree to form new segments, referred to as L1 segments. SHA1 fingerprints of L1 segments are grouped together as L2 segments, and this continues up to L6 which represents the entire file. The top segment of the tree is always an L6 segment, even though it may refer to any lower numbered segments. Segments above L0 are referred to as Lp chunks. The L6 segment of every file is stored in a namespace which is represented as a B+ Tree. The L0 and Lp segments are written to separate containers, known as L0 and Lp containers.

A Data Domain or similar system can efficiently copy an existing file using the same underlying Merkle tree. It creates the new file with a new name, and therefore a new L₆ root of the tree, but that tree then references the identical L_{P} chunks. As this operation involves only the root of the tree, it is trivially fast and does not increase physical space in use beyond the one chunk containing the L₆.

In an embodiment, the PPDM (PowerProtect Data Manager) microservices layer 204 builds on the Data Domain system 206 to provide data protection capabilities for VM image backups and Kubernetes workloads.

Upon creation of an Mtree, it can identify the domain on which the Mtree is created. All namespace metadata as well as the file data and metadata associated with a Mtree is allocated from resources owned by that domain. The Mtree names as well as Mtree IDs are unique across the cluster. Santorini exposes a global namespace that is a union of all namespaces in all domains.

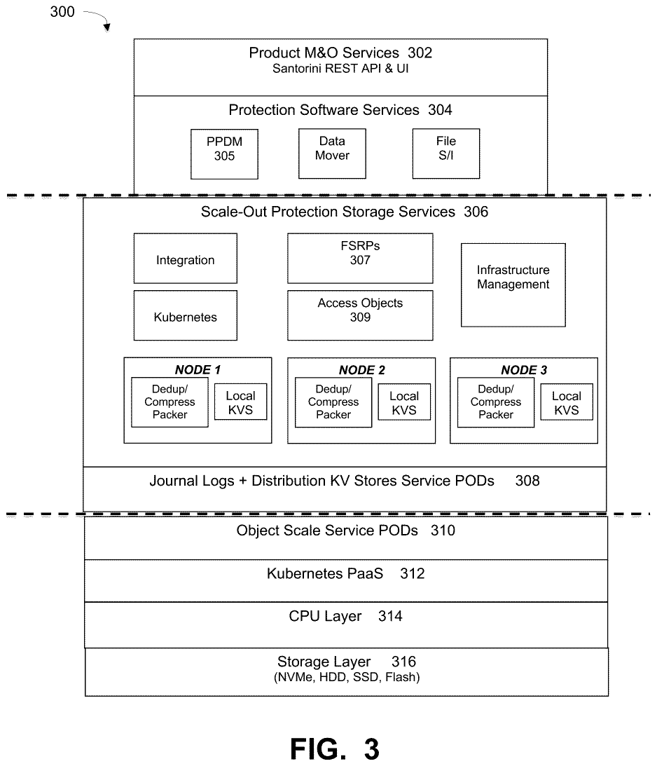

FIG. 3 illustrates details of the services related to the data path running in Santorini cluster network, under some embodiments. As shown in diagram 300, a product services layer 302 provides the necessary REST APIs and user interface utilities. The API server implements a RESTful interface, allowing many different tools and libraries can readily communicate with it. A client called kubecfg is packaged along with the server-side tools and can be used from a local computer to interact with the Kubernetes cluster.

Below layer 302, the protection software services layer 304 includes a data manager (e.g., Power Protect Data Manager, PPDM) component 305 that provides backup software functionality. Within the scale-out protection storage services layer 306, the File System Redirection Proxy (FSRP) service 307 redirects file operations in a consistent manner based on the hash of a file handle, path, or other properties to instance of the access object service 309. The access object service 309 handles protocols and a content store manager. This means that files are segmented and the Lp tree is constructed by an access object 309. The FSRP 307 redirects file system accesses in a consistent way to the access objects 309 so that any in-memory state can be reused if a file is accessed repeatedly in a short time, and it avoids taking global locks. Also included in layer 306 are any number of nodes (e.g., Nodes 1 to 3, as shown), each containing a dedup/compression packer and a key-value (KV) store.

As an L1 is formed, a similarity group (simgroup) is calculated for the L1 based on the SHA1 fingerprints of the L0 segments (or other properties). The similarity group is checked against a mapping table, which leads to consistently routing the L1 based on its similarity group to an instance of a node's dedup/compress service. If similarity groups are in a range of 0-1023, then if there are four instances of the dedup/compress service, then the instances may uniquely be responsible for the ranges 0-255, 256-511, 512-767, 768-1023, though other mappings are possible. The dedup/compress instance will deduplicate the L0 segments relative to other fingerprints within the same similarity group. Other functionality exists in the dedup/compress service such as packing segments into compression regions, containers, and blobs that will be written to an underlying object storage such as provided by the object scale service layer 310, or an object store provided by the public cloud. Other layers of system 300 include a Kubernetes PaaS (platform as software) 312, a CPU layer 314, and a storage layer 316.

Distributed key value stores in 308 are also a component of Santorini and are used to hold much of the metadata such as the namespace Btree, the Lp tree, fingerprint index, and container fingerprints. These run as containers within the Santorini cluster and are stored to low latency media such as NVMe 316. There is also a distributed and durable log that replaces NVRAM for Santorini.

In summary, Santorini is an integrated scale out software solution developed by Dell Technologies that can run on-premises or in a public cloud. In an embodiment, the Santorini stack consists of PPDM as backup software, Data Domain scale out file system, and Object Scale as a storage pool, and these are run as services inside the Kubernetes container infrastructure. The Santorini scale-out file system consists of stateless independent Data Domain services which are responsible for data path. The state of Santorini file system is maintained in three components wherein data is put in object scale, metadata is stored in a distributed key value store (KVS), and logs are stored in a distributed log. The metadata and data can be logged at different rates by the various layers and components of system 300, thus adding complexity to the task of providing a synchronized point for crash recovery using these logs.

As shown in FIG. 1, network 101 includes a logging service or data logger 118 that facilitates the generation and processing of logs and log files for users, components, applications, and so on. Process 112 may be a process executed by a specialized node as a specially configured management or control node in system 100. Alternatively, it may be executed as a server process, such as by server 102 or any other server or client computer in the system. The logging service also generates a high-speed recovery log 119 to store recently written data in order to optimize write performance.

### Recovery Log

In a cluster network, each component/product has many services, and often many different instances of each service. Services may be started, stopped, and re-started, even on different nodes. The distributed logging service and infrastructure 118 processes a recovery (or journal) log for data stored in the system. It essentially works as a distributed persistent cache to speed up writes coming into the system. This can be distinguished from other types of “logging” that may be performed for debugging purposes, but that are not related to the distributed log 112. The distributed logging service 118 provides a scalable, persistent, replicated and consistent log for components in Santorini, and can run on any storage media (e.g., HDD, SSD), but is typically optimized for low latency storage media like NVMe SSDs or other NVRAM devices.

In general, a log, such as recovery log 119 in FIG. 1 is the simplest storage abstraction which is append only and totally ordered. Databases and file systems use logging to provide atomicity and durability of data structures in the presence of system crashes. They write the records/pages or changes to the pages in the log which acts as a history of changes. This may be called an intent log in the context of file systems, or a transaction log in the context of databases. Before performing an operation, a record of the intent to perform it is written to storage, such as hard disk (HDD). After the operation is performed, another record is written as an operation will usually change some data in a system. In some cases, the intent record will contain a copy of the data before and after the operation, which necessarily adds some processing overhead, as enough data must be written to the log to either redo or to undo the operation later. After a system event, the system uses the intent log to identify operations that were still in process during the failure and recover the data, usually by either undoing a partially completed operation, or by redoing any in process operation. It should be noted that a log is not a file and does not provide any file system semantics. For example, there is no close, random read/write or overwrite of a log.

Embodiments of system 100 of FIG. 1 include a cluster-wide consistency point process 112 that collects the times that each deduplication domain was persisted to storage and computes a cluster wide synchronization (sync) point that can be used as a data recovery snapshot point. This process provides a single, cluster-wide consistency point as a time stamp, or similar marker in which all of the data that has been written prior to this point has been synced to storage. In the case of a lost or corrupt recovery log, the system can recover the file system from a snapshot which was taken at or prior to this cluster-wide consistency point. Such a consistency point is referred to herein as a data recovery snapshot.

In general, a snapshot refers to a snapshot backup that comprises a point-in-time backup of a file system taken on a periodic basis defined by a data protection program. A full backup is usually a comprehensive copy for long-term storage and full recovery of the file system, while a snapshot captures the state of a system, database, file, or virtual machine, etc., and is intended primarily for quick recovery or system rollback. A snapshot stores the metadata encoding the location of data blocks and are stored on the same storage as the original data.

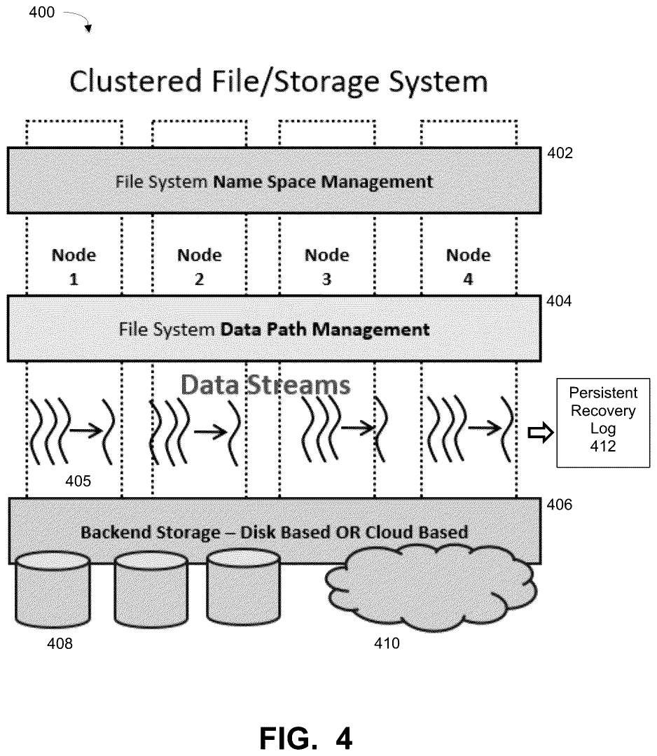

FIG. 4 shows an example clustered file system that implements a cluster-wide consistency point, under some embodiments. In contrast to a single-node system in which one node runs the entire stack of the file system, clustered system 400 comprises a number of nodes, such as nodes 1, 2, 3, and 4, though any number are possible. The nodes are managed by a file system namespace management layer 402 and a file system data path management layer 404. The nodes generate data streams 405 that are processed by backend storage layer 406 for storage in appropriate disk 408 or cloud storage 410.

The operations involved in generating and processing the data streams 405 are stored in one or more recovery logs, and due to resource limitations, only recently written data can be store, meaning that log data over a certain age must be flushed. That is, the recovery log is flushed (or cleared) periodically.

As stated above, in a clustered file system, flushing data staged in recovery logs every N minutes is very expensive due to certain constraints or challenges. One such challenge is storage fragmentation. In order to achieve higher storage performance and reduce metadata overhead, file systems chose to write large, fixed sized blocks or objects to storage. As an example, a Data Domain clustered file system writes 16 MB fixed sized objects to storage, and it generally takes time to completely fill such large objects with data. While objects are being filled with data in memory, their content is staged in the recovery log. When a flush is issued, there are usually many such partially filled objects residing in memory, and the filesystem is forced to flush them to storage, causing storage fragmentation. This fragmentation gets worse as the number of recovery logs grows in number. It also gets worse with larger object sizes. The frequency of the flushes can also deteriorate this storage fragmentation. This gets worse as some of the log-structured file systems do not modify already written objects to storage.

Another challenge is increased storage load. The frequency of flushes and the number of recovery logs which need to be flushed also causes an increased load on the storage system due to excessive number of I/O operations.

Instead of flushing all the staged data periodically, embodiments of process 112 provide an efficient approach for gathering a cluster-wide consistency point which can be used for data recovery.

As stated above, in a clustered environment, such as system 400, a deduplication domain logs data independently into a persistent recovery log 412. The rate of logging of data to this persistent log varies across deduplication domains (or similarity groups) and depends on the file ingest rate of that domain. Embodiments of the persistent recovery log and log processing system address this issue by providing a comprehensive consistency point for recovery by creating a single point in time or cluster-wide consistency point for file system recovery, and from data that is stored on disk. This solution is applicable for recovery logs that are generated at different rates, as well as log files that may themselves have been corrupted.

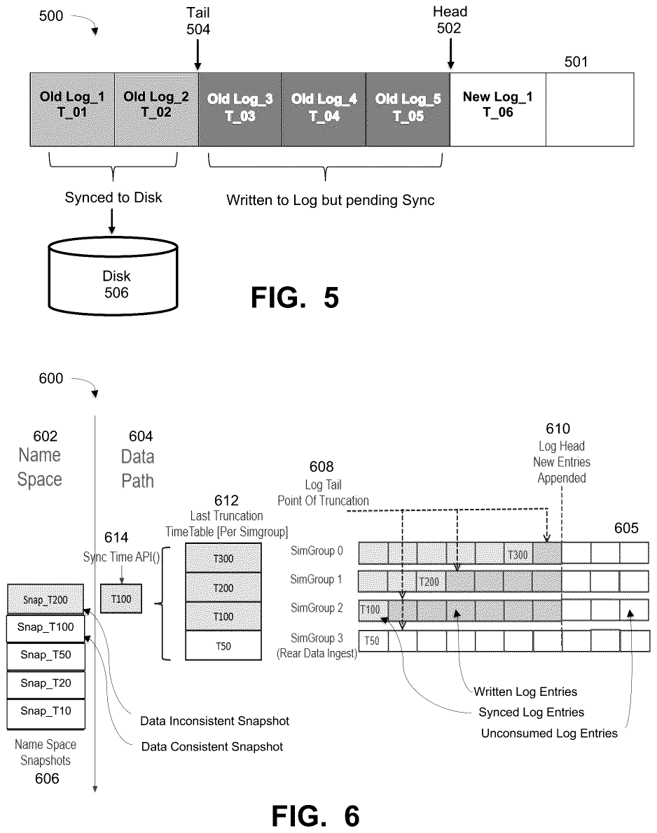

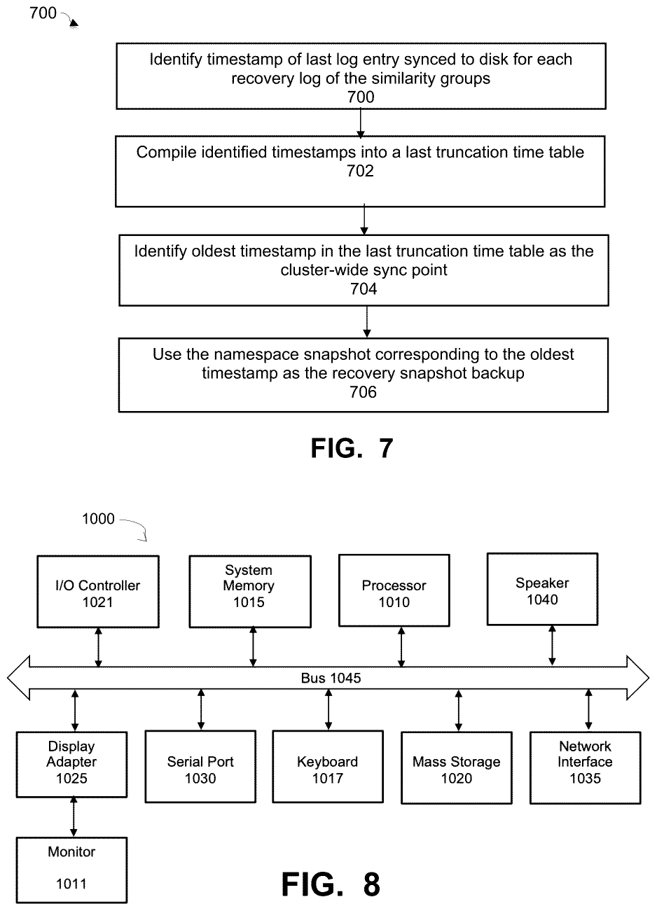

FIG. 5 illustrates a structure of an example recovery log for a similarity group, under some embodiments. The log 500 comprises a number of log entry units 501 of a certain size (e.g., 16 MB) that are each timestamped at the time of writing (e.g., T_0x). New writes get appended to the head 502 of the recovery log and logged writes get truncated from the tail 504 of the recovery log. When a log entry unit 501 is completely full, it is written (or synced) to disk storage, and this write represents a log truncation. Thus, log truncation happens when the log entry unit is close to full, and the rate of the truncation varies across logs and it depends on the rate of ingest specific to that deduplication domain.

For the example of FIG. 5, the recovery log 500 includes a number of old logs denoted Old_Log_1 to Old_Log_5. Each old log is stamped with its respective timestamp as denoted T_01 to T_05. The log entry units for the first two old logs is full and so these have been synced to disk 506, and the log 500 is truncated at the tail 504, which corresponds to the oldest log entry unit that is not full, i.e., Old_Log_3. As shown in the example, old logs 3 to 5 are written to the log, but are not yet synced to the disk because their log data does not fill their respective log entry units. As these log entry units are filled, they will in turn be synced to the disk and the tail 504 will move up in time accordingly. New logs are written to the head of 502 of the recovery log 500, which can contain any number of unconsumed (blank or empty) log entry units 501 after the new log entry.

FIG. 5 illustrates an example of a single recovery log for a single similarity group, but a typical embodiment in a cluster network will involve many recovery logs for the different possible similarity groups, such as up to 1024 recovery logs.

In an embodiment, the recovery log 500 is stored in NVRAM to allow the system to respond to user requests with a very low response time.

FIG. 6 illustrates a system providing a consistent recovery point for many disparate recovery logs in a cluster system, under some embodiments. System 600 of FIG. 6 shows four example similarity groups denoted SimGroup 0, SimGroup 1, SimGroup 2, and SimGroup 3. A similarity group can be formed by computing hashes of data to determine commonalities among data elements to determine group membership. Similarity groups are typically formed to increase data processing efficiency in large-scale networks with many data sources and/or datasets. Any appropriate hashing and grouping method may be used depending on system configuration and constraints. In a Data Domain system, the similarity groups may represent different deduplication domains, and the number of such domains may be on the order of 1024 domains.

System 600 is a cluster system that comprises a namespace 602 and a separate data path 604. The namespace 602 comprises metadata that is backed up periodically to generate a series of namespace snapshots 606. Snapshot backups may be taken at any appropriate frequency depending on the configuration of the data protection system, such as every 15 or 30 minutes, or similar time period.

The example of FIG. 6 shows four recovery logs 605 for the similarity groups (SimGroup 0 to 3). The recovery logs contain log entry units that may be in different states (as shown in FIG. 5) comprising unconsumed or unused log entries (shown in white), written log entries (shown in dark shade), and synced log entries (shown in light shade). The log head 610 demarcates the log entries to the right that are yet to be filled or appended (unconsumed). The log entries shown in yellow color are currently in the log. The synced log entries are truncated from the log since they have already been persisted to storage and are to the left of the log tail 608 for a respective log. The log entries between the log tail 608 and log head 610 are log entries that have been written to the log, but not yet synced to disk.

Log entries that have been synced to storage can be included in the data recovery snapshot 606, while log entries that are still in the log but have not been synced cannot be included in the snapshot because they may not have been persisted to storage.

Each similarity group generate its own recovery log and different similarity groups will fill their logs at different rates, thus leading to different synchronization periods relative to the periodic file system snapshot operations. Thus, as shown for the example of FIG. 6, the log tails 608 that represent the point of truncation are different for each of the recovery logs. This truncation at different points in time presents a challenge in obtaining a single data recovery snapshot for all similarity groups.

In an embodiment, the last stored sync point (or time) of each similarity group is stored in a persisted table 612, referred to as a last truncation time table (LTT table). This table contains n entries, one for each similarity group. Each entry consists of the time stamp of the last entry that was truncated from the corresponding recovery log. This time stamp is not the time that the entry was truncated, but rather the time the entry was appended to the log. In FIG. 6, SimGroup 0 has a last entry that was truncated from the log at a time stamp of T300, which is the time the entry was appended to the log. Likewise, SimGroup 1 has a last truncated entry appended at T200, and SimGroup 2 has a last truncated entry appended at T100. SimGroup 3 has a recovery log that is completely empty, which means that all of its previously logged entries have been synced to storage.

For the example embodiment of FIG. 6, it can be seen that that all of the synced log entries can be included in a common data recovery snapshot because they all have been synced to storage even though they were all appended to their respective logs at different times (i.e., T100, T200, and T300. From this, it can be deduced that all entries logged at or before T100 have already been synced to disk, which means that if the minimum of the time stamps for all similarity groups constitutes a common time stamp which can be used for the data recovery snapshot.

The time stamps in the table 612 are updated as the log entries are truncated from the log. Every time a log entry is truncated from the log, the time stamp is updated in the table with the time at which this log entry was appended to the log. In an embodiment, a sync time function or API 614 is provided that iterates over the entries in the table and computes the minimum time stamp. This minimum time value can then be stored in suitable storage, such as a key-value store, and the API can be used by any file system component to find a snapshot suitable for data recovery. For the example of FIG. 6, API 614 returns T100 which indicates that all snapshots taken at or prior to this time can be used for data recovery. Snapshots taken after this time contain data staged in recovery logs but that are not guaranteed to have the log data synced to storage.

As shown in FIG. 6, the different recovery logs are filled at different rates depending on the activity of the components of the similarity groups that generate the log data. Some SimGroups are active and will generate a lot of log data within a certain period of time, while other SimGroups may not generate much log data at all, and can be referred to as “lazy” SimGroups. For the example of FIG. 6, SimGroup0 is an active group as evidenced by the fact that it has many log entries synced to disk relative to written but un-synced log entries, while SimGroup1 can be considered a lazy group in that it has relatively few synced log entries compared to written but un-synced log entries.

With respect to lazy groups, in some cases, the data distribution amongst similarity groups will not be perfectly uniform. When this happens, some SimGroups could be busy, while others could be less busy, i.e. “lazy.” The lazy sim groups may have bad data sitting in memory for a long period of time. In order to reduce the data loss window for the busy similarity groups, the system can be configured to monitor all SimGroups and their last sync points. If the sync point has passed some pre-determined threshold (e.g., 30 min or similar) or if the rate of ingest to a particular SimGroup is very low, the system can force a sync to disk for that group. This process will help generate a new, more recent, consistency point for the whole cluster.

In FIG. 6, SimGroup3 represents a group with no log entries, or a group that has synced all of its existing log entries and that is ready to populate its recovery log with fresh logs.

Embodiments can persist the last sync point of each similarity group in any form of reliable stable storage.

In an embodiment, the sync time API 614 can be triggered upon detection of an issue causing disruption of the cluster file system or corruption of a log file. Alternatively, the sync process can be initiated through a defined utility that parses the recovery logs, extracts all log entry timestamps and generates a cluster-wide timestamp as a common synchronization point for the backup image. This cluster-wide time stamp can be used instead of the API to find a snapshot suitable for data recovery.

Instead of providing an API inside the file system that returns the cluster-wide time stamp by querying the KVS table, the time stamp can also be determined if it stores each recovery log time stamp in another location such as debug/serviceability logs, and a utility (such as script) is used to parse, extract, and compute the cluster-wide time stamp.

With respect to a cluster file system, the cluster-wide consistent sync point process provides benefits such as avoiding the need for a cluster-wide sync operation for taking a recovery snapshot. It also reduces data loss by providing the ability to find a suitable snapshot for data recovery, and reduces storage fragmentation by avoiding frequent and synchronized flushing of staged data from recovery logs. It also reduces pressure on back-end storage system caused by frequent flushing of staged data.

With respect to the system implementation of system 600 in an overall cluster system 300 of FIG. 3, the namespace 602 and its constituent components run inside Access Objects 309. Likewise, the data path 604 and its constituent components run inside Dedup/Compress/Packer component shown in each of the nodes (e.g., Node 1, Node 2, Node 3 in FIG. 3), and the LTT table 610 is stored in a KVS, which is shown as the journal logs+distribution KV stores service pods 308 in FIG. 3. The API described above can be provided in the access objects 309. This describes one possible implementation of system 600 in a cluster system, and other component implementations and assignments are also possible.

Embodiments of the processes and techniques described above can be implemented on any appropriate backup system operating environment or file system, or network server system. Such embodiments may include other or alternative data structures or definitions as needed or appropriate. The processes described herein may be implemented as computer programs executed in a computer or networked processing device and may be written in any appropriate language using any appropriate software routines. For purposes of illustration, certain programming examples are provided herein, but are not intended to limit any possible embodiments of their respective processes.

The network of FIG. 1 may comprise any number of individual client-server networks coupled over the Internet or similar large-scale network or portion thereof. Each node in the network(s) comprises a computing device capable of executing software code to perform the processing steps described herein. FIG. 8 is a block diagram of a computer system used to execute one or more software components of a logging and audit log generation processing component, under some embodiments. The computer system 1000 includes a monitor 1011, keyboard 1017, and mass storage devices 1020. Computer system 1000 further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 is an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules. Alternatively, the computer software products may be classes that may be instantiated as distributed objects. The computer software products may also be component software. An operating system for the system may be one of the Microsoft Windows®. family of systems (e.g., Windows Server), Linux, Mac™ OS X, IRIX32, or IRIX64. Other operating systems may be used.

Embodiments can include computer-readable storage medium containing computer-readable instructions or computer program code. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information.

Although certain embodiments have been described and illustrated with respect to certain example network topographies and node names and configurations, it should be understood that embodiments are not so limited, and any practical network topography is possible, and node names and configurations may be used.

Embodiments may be applied to data, storage, industrial networks, and the like, in any scale of physical, virtual or hybrid physical/virtual network, such as a very large-scale wide area network (WAN), metropolitan area network (MAN), or cloud-based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network. The network may comprise any number of server and client computers and storage devices, along with virtual data centers (vCenters) including multiple virtual machines. The network provides connectivity to the various systems, components, and resources, and may be implemented using protocols such as Transmission Control Protocol (TCP) and/or Internet Protocol (IP). In a distributed network environment, the network may represent a cloud-based network environment in which applications, servers and data are maintained and provided through a centralized cloud-computing platform.

Some embodiments of the invention involve data processing, database management, and/or automated backup/recovery techniques using one or more applications in a distributed system, such as a very large-scale wide area network (WAN), metropolitan area network (MAN), or cloud based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

Although embodiments are described and illustrated with respect to certain example implementations, platforms, and applications, it should be noted that embodiments are not so limited, and any appropriate network supporting or executing any application may utilize aspects of the backup management process described herein. Furthermore, network environment 100 may be of any practical scale depending on the number of devices, components, interfaces, etc. as represented by the server/clients and other elements of the network. For example, network environment 100 may include various different resources such as WAN/LAN networks and cloud networks 102 are coupled to other resources through a central network 110.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of providing a cluster-wide synchronization point for use as a data recovery snapshot in a cluster file system, comprising:
first accessing recovery logs for a plurality of similarity groups of the cluster file system, wherein each similarity group maintains a respective recovery log, and wherein the recovery logs are loaded with log data at different rates;
second accessing snapshot backups of the cluster file system taken on a periodic basis;
determining an earliest time of storage to disk of log data in the recovery logs; and
utilizing a snapshot backup taken at a time corresponding to the earliest time as a backup image to restore the system in the event of a crash of the cluster file system or corruption of one or more of the recovery logs.

2. The method of claim 1 wherein the snapshot backups comprise point-in-time backups of the cluster system taken on a periodic basis defined by a data protection program.

3. The method of claim 2 wherein the recovery logs each comprise log data units of a fixed size to receive relevant log data, and further wherein the log data comprises transaction data generated by one or more applications of the cluster file system.

4. The method of claim 3 wherein each recovery log writes log data to disk storage when a log data unit is full to sync log data of a full log data unit to the disk storage.

5. The method of claim 4 further comprising:
truncating a recovery log at a full log data unit to form a log tail; and
appending new log data to a log head comprising an empty log data unit after one or more partially full log data units after the log tail.

6. The method of claim 4 wherein log data units are each on the order of multiple megabytes and are stored in non-volatile RAM (NVRAM) based storage.

7. The method of claim 1 wherein the cluster system comprises a Santorini network processing containerized data utilizing a Kubernetes-based framework, and wherein the cluster system comprises part of a Data Domain deduplication backup system performing backup and restore operations for the nodes.

8. The method of claim 7 wherein a number of the similarity groups and corresponding recovery logs is on the order of up to 1024.

9. The method of claim 1 wherein the determining and utilizing steps are initiated upon one of: detection of an issue causing disruption of the cluster file system or corruption of a log file, or through a defined utility that parses the recovery logs, extracts all log entry timestamps and generates a cluster-wide timestamp as a common synchronization point for the backup image.

10. A method of providing a cluster-wide synchronization point for use as a data recovery snapshot in a cluster file system having similarity groups generating log data, comprising:
filling a recovery log of a plurality of recovery logs each organized into a plurality of uniform log data units with log data generated by a corresponding similarity group, wherein the recovery logs are filled at different rates;
syncing, when a log data unit is filled, corresponding log data to disk storage;
truncating the recovery log at the filled log data unit to define a log tail;
appending new log data to a log head comprising a first empty log data unit after any partially filled log data units;
marking, with a timestamp, each filled log data unit with a time corresponding to when it is synced to the disk storage;
identifying an earliest timestamp of the marked filled log data units; and
matching the earliest timestamp with a snapshot backup of the cluster file system taken at a same corresponding time for use as a backup image for restoring the cluster file system.

11. The method of claim 10 wherein the snapshot backups comprise point-in-time backups of the cluster system taken on a periodic basis defined by a data protection program, the method further comprising:
taking successive point-in-time backups on a periodic basis;
performing the matching step to identify the snapshot backup as a data consistent snapshot; and
characterizing other snapshot backups as data inconsistent snapshots.

12. The method of claim 11 wherein the synching step is initiated upon one of: detection of an issue causing disruption of the cluster file system or corruption of a log file, or through a defined utility that parses the recovery logs, extracts all log entry timestamps and generates a cluster-wide timestamp as a common synchronization point for the backup image.

13. The method of claim 11 wherein the recovery logs each comprise log data units of a fixed size to receive relevant log data, and further wherein the log data comprises transaction data generated by one or more applications of the cluster file system.

14. The method of claim 13 wherein log data units are each on the order of multiple megabytes and are stored in non-volatile RAM (NVRAM) based storage.

15. The method of claim 14 wherein the cluster system comprises a Santorini network processing containerized data utilizing a Kubernetes-based framework, and wherein the cluster system comprises part of a Data Domain deduplication backup system performing backup and restore operations for the nodes.

16. The method of claim 15 wherein a number of the similarity groups and corresponding recovery logs is on the order of up to 1024.

17. A system providing a cluster-wide synchronization point for use as a data recovery snapshot in a cluster file system, comprising:
an interface first accessing recovery logs for a plurality of similarity groups of the cluster file system, wherein each similarity group maintains a respective recovery log, and wherein the recovery logs are loaded with log data at different rates, and second accessing snapshot backups of the cluster file system taken on a periodic basis;
a recovery log processor filling a recovery log of a plurality of recovery logs each organized into a plurality of uniform log data units with log data generated by a corresponding similarity group, wherein the recovery logs are filled at different rates, truncating the recovery log at the filled log data unit to define a log tail, and appending new log data to a log head comprising a first empty log data unit after any partially filled log data units;
a synchronization component determining an earliest time of storage to disk of log data in the recovery logs; and
a data protection component utilizing a snapshot backup taken at a time corresponding to the earliest time as a backup image to restore the system in the event of a crash of the cluster file system or corruption of one or more of the recovery logs.

18. The system of claim 17 wherein the snapshot backups comprise point-in-time backups of the cluster system taken on a periodic basis defined by a data protection program, and further wherein the recovery logs each comprise log data units of a fixed size to receive relevant log data, and further wherein the log data comprises transaction data generated by one or more applications of the cluster file system.

19. The system of claim 18 wherein the cluster system comprises a Santorini network processing containerized data utilizing a Kubernetes-based framework, and wherein the cluster system comprises part of a Data Domain deduplication backup system performing backup and restore operations for the nodes.

20. The system of claim 19 further comprising a trigger component configured to detect an issue causing disruption of the cluster file system or corruption of a log file, or execute through a defined utility that parses the recovery logs, extracts all log entry timestamps and generates a cluster-wide timestamp as a common synchronization point for the backup image.
